(19) United States
(12) Patent Application Publication
(10) Pub. No.: US 2026/0241922 A1
(43) Pub. Date: Aug. 20, 2026

(54) DRIVING ASSIST SYSTEM, DRIVING ASSIST METHOD, AND DRIVING ASSIST PROGRAM STORED ON NONTRANSITORY STORAGE MEDIUM

(71) Applicants: J-QuAD DYNAMICS Inc., Tokyo (JP); DENSO CORPORATION, Kariya-city (JP); AISIN CORPORATION, Kariya (JP); JTEKT CORPORATION, Kariya-shi (JP); ADVICS CO., LTD., Kariya-city (JP)

(72) Inventors: Takuto KOZAKI, Tokyo (JP); Tomoya INAYOSHI, Tokyo (JP)

(21) Appl. No.: 19/468,743

(22) Filed: Feb. 3, 2026

(30) Foreign Application Priority Data
Feb. 7, 2025 (JP) 2025-019444

(51) Int. Cl. B60W 30/045; B60W 10/18; B60W 10/20; B60W 30/18; B60W 40/109; B62D 7/15

(52) U.S. Cl. CPC B60W 30/045; B60W 10/18; B60W 10/20; B60W 30/18172; B60W 40/109; B62D 7/159; B60W 2510/20; B60W 2510/205; B60W 2520/125; B60W 2520/14; B60W 2520/20; B60W 2552/30; B60W 2552/40; B60W 2710/18; B60W 2710/207; B60W 2720/125; B60W 2720/14

(57) ABSTRACT

A driving assist system for assisting driving of a host vehicle is provided. The driving assist system plans a target path of the host vehicle, and controls motion of the host vehicle in accordance with the target path by adjusting a front wheel steering angle and a rear wheel steering angle. In planning the target path, the driving assist system calculates the target path where a vehicle body slip angle and a yaw rate are generated when the host vehicle is decelerated with lateral movement so that the vehicle body slip angle is due to controlling the front wheel steering angle and the rear wheel steering angle in phase with each other and the yaw rate is due to a difference between the front wheel steering angle and the rear wheel steering angle.

### CROSS REFERENCE TO RELATED APPLICATION

The present application claims the benefit of priority from Japanese Patent Application No. 2025-019444 filed on Feb. 7, 2025. The entire disclosure of the above application is incorporated herein by reference.

### TECHNICAL FIELD

The present disclosure relates to a driving assist technology for assisting driving of a vehicle.

### BACKGROUND

There is a vehicle behavior control system that assists driving of a vehicle via controlling steering of wheels. There are needs to improve a driving assist technology for assisting driving of a vehicle.

### SUMMARY

According to one aspect of the present disclosure, a driving assist system for assisting driving of a host vehicle is provided. The driving assist system plans a target path of the host vehicle and controls motion of the host vehicle in accordance with the target path by adjusting a front wheel steering angle and a rear wheel steering angle. In planning the target path, the driving assist system calculates the target path where a vehicle body slip angle and a yaw rate are generated when the host vehicle is decelerated with lateral movement so that the vehicle body slip angle is due to controlling the front wheel steering angle and the rear wheel steering angle in phase with each other and the yaw rate is due to a difference between the front wheel steering angle and the rear wheel steering angle.

### BRIEF DESCRIPTION OF DRAWINGS

Objects, features, and advantages of the present disclosure will become apparent from the following detailed description made with reference to the accompanying drawings.

FIG. 1 is a block diagram illustrating a driving assist system as a whole according to one embodiment of the present disclosure.

FIG. 2 is a diagram for description of motion of a host vehicle in a scene where a pedestrian is circumvented by a driving assist function.

FIG. 3 is a diagram illustrating a relationship between a lateral speed of the host vehicle and a vehicle body slip angle during in-phase steering.

FIG. 4 is a diagram illustrating a relationship between a longitudinal force and a lateral force on the tire.

FIG. 5 is a flowchart illustrating details of a driving assist method executed by the driving assist system.

FIG. 6 is a time chart illustrating details of the driving assist method.

FIG. 7 is a time chart illustrating details of a process of adjusting deceleration in accordance with start of steering control.

FIG. 8 is a diagram illustrating a margin of a tire lateral force necessary for steering control.

FIG. 9 is a time chart illustrating details of feedback control.

### DETAILED DESCRIPTION

There is a vehicle behavior control system that controls steering of rear wheels when decelerating while circumventing an obstacle. The vehicle behavior control system increases a lateral movement amount of the vehicle by steering the rear wheel in a direction in opposite phase with a circumvention direction.

In this driving assist technology, when a large braking force is generated, a lateral force on the rear wheel steered in the opposite phase may not be sufficient, and the lateral movement amount due to yaw motion may reduce. In addition, a tire lateral force generated by a rear wheel steering angle to the opposite phase may exceed a limit of a friction circle, which may encourage slip in a longitudinal direction and cause the vehicle to be unstable.

It is an object of the present disclosure to provide a driving assist system, a driving assist method, and a driving assist program that can suppress reduction in lateral movement amount while ensuring vehicle stability.

According to a first aspect of the present disclosure, a driving assist system is provided that comprise a computer, including at least one processor, configured to execute: planning a target path of the host vehicle; and controlling motion of the host vehicle in accordance with the target path by adjusting, with respect to a reference longitudinal direction, a front wheel steering angle of a front wheel unit and a rear wheel steering angle of a rear wheel unit which are given from steering actuators. Planning the target path includes calculating the target path where a vehicle body slip angle and a yaw rate are generated when the host vehicle is decelerated with lateral movement, wherein the vehicle body slip angle is due to controlling the front wheel steering angle and the rear wheel steering angle in phase with each other with respect to the reference longitudinal direction and the yaw rate is due to a difference between the front wheel steering angle and the rear wheel steering angle.

According to a second aspect of the present disclosure, a driving assist method is provided that is executed by a computer including at least one processor for assisting driving of a host vehicle and that comprises: planning a target path of the host vehicle; and controlling motion of the host vehicle in accordance with the target path by adjusting, with respect to a reference longitudinal direction, a front wheel steering angle of a front wheel unit and a rear wheel steering angle of a rear wheel unit which are given from steering actuators. Planning the target path includes calculating the target path where a vehicle body slip angle and a yaw rate are generated when the host vehicle is decelerated with lateral movement, wherein the vehicle body slip angle is due to controlling the front wheel steering angle and the rear wheel steering angle in phase with each other with respect to the reference longitudinal direction and the yaw rate is due to a difference between the front wheel steering angle and the rear wheel steering angle.

According to a third aspect of the present disclosure, a driving assist program is provided that is stored on at least one non-transitory storage medium for assisting driving of a host vehicle and that comprises instructions causing a computer to execute: planning a target path of the host vehicle; and controlling motion of the host vehicle in accordance with the target path by adjusting, with respect to a reference longitudinal direction, a front wheel steering angle of a front wheel unit and a rear wheel steering angle of a rear wheel unit which are given from steering actuators. Planning the target path includes calculating the target path where a vehicle body slip angle and a yaw rate are generated when the host vehicle is decelerated with lateral movement, wherein the vehicle body slip angle is due to controlling the front wheel steering angle and the rear wheel steering angle in phase with each other with respect to the reference longitudinal direction and the yaw rate is due to a difference between the front wheel steering angle and the rear wheel steering angle.

In the above, when the host vehicle is decelerated with lateral movement, the rear wheel steering angle is controlled in phase with the front wheel steering angle, so that the host vehicle is less likely to become unstable. In addition, because the yaw rate is generated by the difference in steering angle between the front wheel and the rear wheel steered in phase with each other, ensuring a lateral movement amount is facilitated. According to the above, even when the host vehicle is decelerated with lateral movement, it is possible to suppress reduction in lateral movement while ensuring vehicle stability.

Embodiments will be described with reference to the drawings.

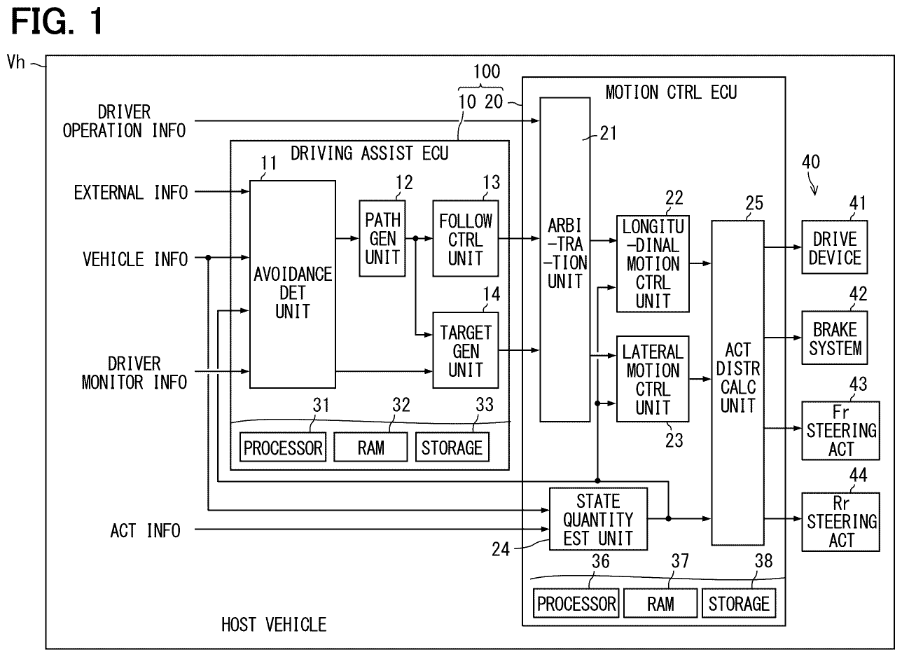

A driving assist system 100 according to one embodiment of the present disclosure shown in FIG. 1 assists driving of a host vehicle Vh. At least part of the driving assist system 100 is mounted to the host vehicle Vh. Among driving automation levels specified in, for example, SAE J3016, etc., the host vehicle Vh applied with the driving assist system 100 can implement a level where an automatic driving task is present together with a manual driving task for assisting manual driving of an operator. The host vehicle Vh is a road user, for example, a car, a truck, a bus, etc. The host vehicle may be also called an ego-vehicle. A driving assist target of the driving assist system 100 is an operator of the host vehicle Vh and may be a driver in a cabin of the host vehicle Vh who can manually drive the host vehicle Vh.

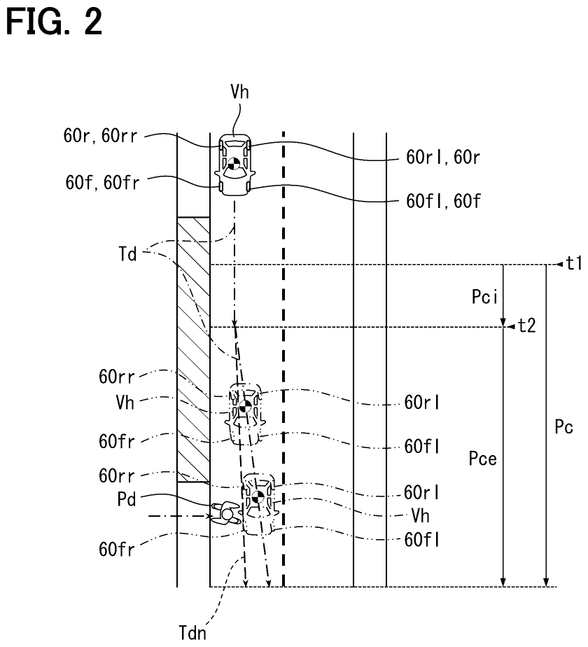

As shown in FIG. 2, in a driving environment where the host vehicle Vh travels, a traffic scene is assumed where at least one object other than the host vehicle Vh is present. The object other than the host vehicle Vh may be another road user, a structure, etc. The object other than the host vehicle Vh includes a vulnerable road user and a non-vulnerable road user depending on their vulnerability. The vulnerable user is, for example, human, for example, a pedestrian Pd. The non-vulnerable road user is, for example, at least a vehicle of one kind onboard a human occupant among a car, a truck, a bus, a motorcycle, a bicycle, etc.

As shown in FIG. 1, the host vehicle Vh includes an actuator group 40 together with at least part of the driving assist system 100. The actuator group 40 is configured to be able to control a driving action of the host vehicle Vh based on a control command from the driving assist system 100. The actuator group 40 includes a drive device 41, a brake system 42, a front steering actuator 43, and a rear steering actuator 44. The drive device 41 includes, for example, at least a powertrain actuator of one kind among an internal combustion engine, a motor-generator motor, etc.

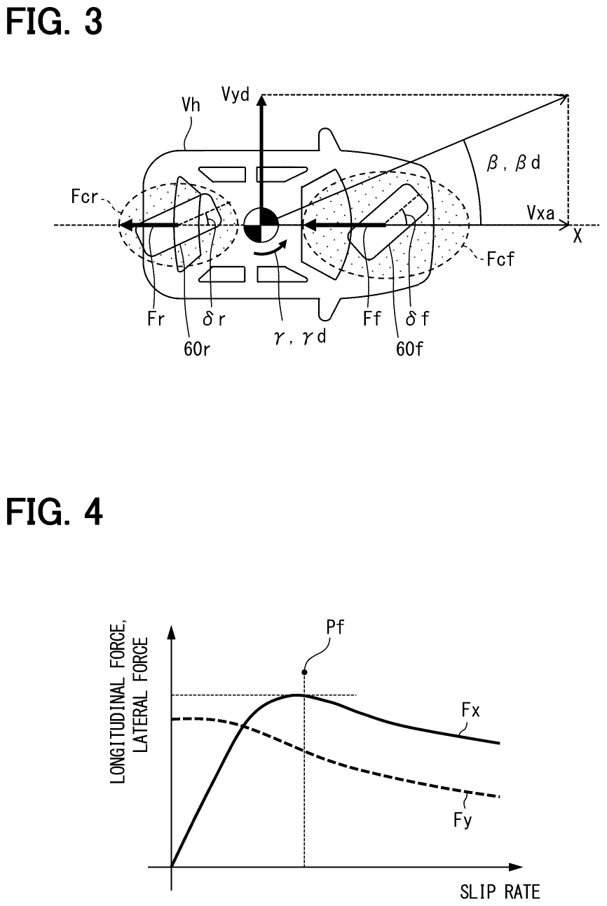

The brake system 42 includes at least a braking actuator of one kind, for example, a brake unit, etc. As shown in FIG. 2, the host vehicle Vh includes a front wheel unit 60f including a right front wheel 60fr and a left front wheel 60fl, and a rear wheel unit 60r including a right rear wheel 60rr and a left rear wheel 60rl. The brake system 42 causes the right and left wheels of the front wheel unit 60f to individually generate a front wheel braking force Ff and the right and left wheels of the front wheel unit 60f to individually generate a rear wheel braking force Fr, as shown in FIG. 3. The brake system 42 hydraulically adjusts the front wheel braking force Ff generated by each wheel of the front wheel unit 60f and the rear wheel braking force Fr generated by the rear wheel unit 60r, independently of each other. Because of this, it is possible for the host vehicle Vh to control left-right distribution and front-rear distribution of the braking force.

Here, the magnitude of the front wheel braking force Ff may be the same or different between the left and right wheels. The magnitude of the rear wheel braking force Fr may be the same or different between the left and right wheels. Furthermore, the magnitude of the front wheel braking force Ff and the magnitude of the rear wheel braking force Fr may be the same in at least one of the left and right wheels or may differ among all of the wheels. The front wheel braking force Ff and the rear wheel braking force Fr are defined so that in a view from the above, a reverse motion direction in the longitudinal direction of the host vehicle Vh is set as a negative direction (or an exact opposite direction relationship).

The brake system 42 may include an ABS (anti-lock brake system) control function so as to able to adjust the front wheel braking force Ff and the rear wheel braking force Fr while suppressing respective slip rates of the front wheel unit 60f and the rear wheel unit 60r from becoming excessive. The front wheel braking force Ff and the rear wheel braking force Fr may be generated using regenerative braking in the drive device 41, such as a drive motor. In this case, by providing the brake system 42 with the ABS control function, the braking force of the regenerative brake of the drive motor may be adjusted according to each slip rate.

The front steering actuator 43 gives a generally same front wheel steering angle of to the right front wheel 60fr and the left front wheel 60fl of the host vehicle Vh. The rear steering actuator 44 gives a generally same rear wheel steering angle δr to the right rear wheel 60rr and the left rear wheel 60rl of the host vehicle Vh. The front steering actuator 43 and the rear steering actuator 44 adjust the front wheel steering angle of given to the front wheel unit 60f and the rear wheel steering angle δr given to the rear wheel unit 60r, independently of each other, by motor torque. Because of this, it is possible for the host vehicle Vh to control a phase relationship between the front wheel steering angle δf and the rear wheel steering angle δr.

The front wheel steering angle δf and the rear wheel steering angle δr are defined so that a reference longitudinal direction X has a phase angle of 0° and a counterclockwise direction around a yaw axis of the host vehicle Vh is positive and a clockwise direction is negative in a view from the above (or an exact opposite direction relationship). It is assumed that the reference longitudinal direction X is the longitudinal direction of the host vehicle Vh in the view from the above. Specifically, the reference longitudinal direction X is assumed to be a forward motion direction. Furthermore, adjusting the phase relationship of the front wheel steering angle δf and the rear wheel steering angle δr with respect to the reference longitudinal direction X in phase with each other requires that the signs of the steering angles of and δr match each other but the magnitudes of the steering angles of and or may match each other or differ from each other. On the other hand, adjusting the phase relationship of the front wheel steering angle δf and the rear wheel steering angle δr with respect to the reference longitudinal direction X in opposite phase with each other requires that the signs of the steering angles of and or differ from each other.

As shown in FIG. 1, in the host vehicle Vh, the driving assist system 100 is configured to acquire driver operation information, external information, vehicle information, driver monitoring information, and actuator information. The driver operation information includes information related to driver's driving operation, such as a rotation angle of a steering wheel (steering wheel angle), a pedal operation amount of each of an accelerator pedal and a brake pedal, etc.

The external information includes sensing information acquired by the external sensor and the ego-vehicle position information of the host vehicle Vh acquired by a GNSS receiver. The external sensor is of at least one type among a vehicle-mounted camera, a millimeter wave radar, a LiDAR (light detection and ranging/laser imaging detection and ranging), a sonar, etc. The external sensor of multiple kinds in combination may be implemented to enable sensing in the forward, the lateral side, the rearward of the host vehicle Vh. The sensing information includes information indicating a relative position, a movement direction, and a movement speed of an object around the vehicle Vh such as a pedestrian Pd.

The vehicle information includes sensing information of the host vehicle Vh acquired by the internal sensor. The internal sensor is, for example, of at least one kind among a speed sensor, an acceleration sensor, a gyro sensor, an inertial sensor, etc. The internal sensor senses a specific vehicle physical quantity related to vehicle motion of the host vehicle Vh. The vehicle information includes information indicating vehicle speed, tire wheel speed, yaw rate, steering angle, a steering torque, etc.

The driver monitoring information includes sensing information acquired by an occupant sensor. The occupant sensor is of at least one kind among a driver monitor, a steering wheel touch sensor, a heart rate sensor, etc. The occupant sensor senses an operation or status of an occupant onboard the host vehicle Vh. The occupant includes the driver.

The actuator information includes status information indicating whether or not the actuator group 40 is operational. The actuator information includes, for example, information indicating whether or not the brake in the brake system 42 is operational and whether or not steering in the front steering actuator 43 and the rear steering actuator 44 is operational.

The driving assist system 100 is connected to the actuator group 40, the external sensor, the internal sensor, and the occupant sensor via, for example, at least one of a LAN (local area network), a wire harness, an internal bus, a wireless communication line, etc. The driving assist system 100 includes at least one dedicated computer. The dedicated computer is implemented in a form of a control circuit (e.g., control ECU) or a semiconductor device (e.g., semiconductor chip). The present embodiment illustrates an example where the driving assist system 100 as a whole is mounted to the host vehicle Vh. The driving assist system 100 includes a driving assist ECU (Electrical Control Unit) 10 and a motion control ECU 20 as dedicated computers.

The dedicated computers constituting the driving assist ECU 10 and the motion control ECU 20 each include at least one processor 31, 36, at least one RAM 32, 37, and at least one storage 33, 38. The processor 31, 36 is a computational processing unit coupled with the RAM 32, 37. The processor 31, 36 includes, for example, a core of at least one kind among a central processing unit (CPU), a graphics processing unit (GPU), and a reduced instruction set computer (RISC)-CPU. The storage 33, 38 non-transitorily stores a program (e.g., a driving assist program, etc.) and data readable by a computer. The storage 33, 38 includes a non-transitory tangible storage medium of at least one kind among a semiconductor memory, a magnetic media, an optical media, etc.

The driving assist ECU 10 plans driving control in the host vehicle Vh. The driving assist ECU 10 is an ADAS domain ECU implementing an AD (autonomous driving) function and a ADAS (advanced driving assist systems) function as the driving control. The driving assist ECU 10 determines whether or not emergency avoidance control is necessary with respect to an object (obstacle) such as a pedestrian Pd, etc., taking into account the driver's operation, etc. If the avoidance is necessary, the driving assist ECU 10 performs following control along a generated target path Td (see FIG. 2).

The processor 31 of the driving assist ECU 10 executes a plurality of instructions included in the driving assist program stored as the software in the storage 33. In this way, functional blocks for assisting obstacle collision avoidance in the driving of the host vehicle Vh are implemented in the driving assist ECU 10. Specifically, the functional blocks implemented in the driving assist ECU 10 include an avoidance determination unit 11, a path generation unit 12, a following control unit 13, and a target generation unit 14.

The avoidance determination unit 11 has a function of recognizing the external and the internal, a function of predicting collision with an obstacle, and a function of determining as to obstacle avoidance. The avoidance determination unit 11 acquires the external information, the vehicle information, and the driver monitoring information. In addition, from the motion control ECU 20, the avoidance determination unit 11 acquires the actuator information indicating feasibility of the in-phase steering and the opposite-phase steering of the front wheel unit 60f and the rear wheel unit 60r. The avoidance determination unit 11 may acquire an estimation result of a vehicle state quantity of the host vehicle Vh and a calculation result of a vehicle response (described later) from the motion control ECU 20.

By using the acquired external information and the acquired vehicle information, the avoidance determination unit 11 generates recognition data on recognition of a state of the external and the internal for each driving scene of the host vehicle Vh. By recognizing an object such as another vehicle, a pedestrian Pd or the like in the external, the avoidance determination unit 11 generates the recognition data indicating the relative position, the movement direction, and the movement speed. In addition, the avoidance determination unit 11 generates the recognition data by recognizing the road where the host vehicle Vh is traveling. The recognition data on the road represents, for example, a road structure of at least one kind among location, shape (curve curvature, road surface cant, etc.), size, and road surface condition.

When the avoidance determination unit 11 recognizes an obstacle existing in the reference longitudinal direction X (forward) of the host vehicle Vh based on forward information of the host vehicle Vh included in the external information, the avoidance determination unit 11 predicts whether or not the obstacle is going to collide with the host vehicle Vh. When the avoidance determination unit 11 predicts that the obstacle is going to collide with the host vehicle Vh, the avoidance determination unit 11 determines that avoidance by the host vehicle Vh is necessary. When the collision with the obstacle is predicted, the avoidance determination unit 11 determines to perform braking control by the brake system 42. In addition, the avoidance determination unit 11 further determines whether or not, in addition to the braking control, steering control is necessary to circumvent the obstacle. When the avoidance determination unit 11 predicts that the braking control alone may result in the collision with the obstacle, the avoidance determination unit 11 determines to perform collision avoidance by lateral movement.

When the avoidance determination unit 11 determines that steering control is necessary to circumvent the obstacle, the avoidance determination unit 11 makes a determination to start each of the braking control and the steering control. In this case, the avoidance determination unit 11 outputs a braking control start flag and a steering control start flag to the path generation unit 12. When the avoidance determination unit 11 determines that the steering control is not necessary, in other words, determines that the obstacle collision is avoidable by the braking control alone, the avoidance determination unit 11 makes a braking control avoidance determination and outputs a braking control start flag to the path generation unit 12.

The path generation unit 12 acquires the recognition data generated by the avoidance determination unit 11, the braking control start flag, the steering control start flag, etc. When it is determined by the avoidance determination unit 11 that the avoidance control is necessary and the path generation unit 12 acquires the braking control start flag and the steering control start flag, the path generation unit 12 plans a target path Td (see FIG. 2) of the host vehicle Vh by using the recognition data. The target path Td is a driving path being a target for the host vehicle Vh to follow in future run.

The path generation unit 12 plans the target path Td as the path to be followed by the host vehicle Vh in the future run, so as to specify a time-series change in position coordinate at each control cycle. The path generation unit 12 generates the target path Td so that a motion parameter at each control cycle on the path directly or indirectly indicates a kinematic physical quantity of at least one kind among speed, acceleration, deceleration, yaw rate γ, and vehicle body slip angle β. Indirectly indicating may mean indicating via conversion operation.

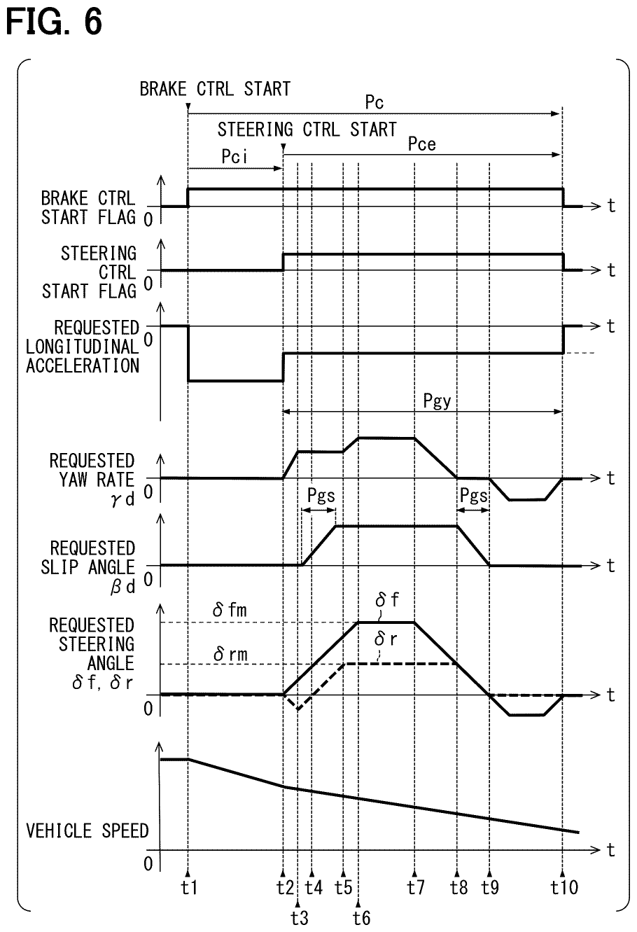

The path generation unit 12 can calculate the target path Td for the avoidance control as such a path where the host vehicle Vh laterally moves while decelerating to circumvent the obstacle such as a pedestrian Pd. Based on the actuator information acquired from the avoidance determination unit 11, the path generation unit 12 ascertains presence or absence of the rear steering actuator 44 and an upper limit value (restriction value) of each of the steering angle and steering angle speed as a hardware constraint. When steering of the rear wheel unit 60r is feasible, the path generation unit 12 determines whether or not to perform the in-phase control and the opposite-phase control of the front wheel steering angle δf and the rear wheel steering angle or. The path generation unit 12 calculates the target path Td for circumventing the obstacle via generating the vehicle body slip angle β and the yaw rate γ, wherein the vehicle body slip angle β is due to controlling the front wheel steering angle δf and the rear wheel steering angle δr in phase with each other and the yaw rate γ is due to a difference between the front wheel steering angle δf and the rear wheel steering angle or. In the above, even in a case of performing the in-phase control of the front wheel steering angle δf and the rear wheel steering angle δr, the front wheel steering angle of and the rear wheel steering angle δr may not always be kept in-phase during a time period where generation of the vehicle body slip angle β is requested. It may suffice that among the time period where generation of the vehicle body slip angle β is requested, a time period during which the front wheel steering angle δf and the rear wheel steering angle δr are kept in in-phase is dominant and the opposite-phase control of the front wheel steering angle δf and the rear wheel steering angle δr may be performed momentarily (see FIG. 6 for time t3 to time t4, etc.).

The following control unit 13 acquires the target path Td planned by the path generation unit 12. The following control unit 13 calculates a yaw rate γ (hereafter, a requested yaw rate yd) and a vehicle body slip angle β (hereafter, a requested slip angle βd) for performing the following control by which the host vehicle Vh travels along the target path Td. The following control unit 13 outputs the requested yaw rate yd and the requested slip angle βd to the motion control ECU 20.

The requested slip angle βd is given by the below mathematical expression 1 using a requested lateral speed Vyd necessary to travel in accordance with the target path Td and an actual longitudinal speed Vxa of the host vehicle Vh.

$$β d = {tan}^{- 1} ( \frac{Vyd}{Vxa} ) ≅ \frac{Vyd}{Vxa} . \qquad ( Mathematical Expression 1 )$$

The target generation unit 14 acquires the target path Td planned by the path generation unit 12. The target generation unit 14 calculates a target deceleration for decelerating the host vehicle Vh along the target path Td (hereafter, a requested longitudinal acceleration). The target generation unit 14 outputs the requested longitudinal acceleration to the motion control ECU 20.

The motion control ECU 20 is a motion domain ECU for controlling motion of the host vehicle. The motion control ECU 20 integrally controls the actuator group 40 as the motion control of the host vehicle Vh. The motion control ECU 20 calculates a request to the actuator group 40 based on the request from the driving assist ECU 10.

The processor 36 of the motion control ECU 20 executes a plurality of instructions included in the driving assist program stored as software in the storage 38. In this way, functional blocks for assisting avoidance of collision with an obstacle in the driving of the host vehicle Vh are implemented in the motion control ECU 20. Specifically, the functional blocks implemented in the motion control ECU 20 include an arbitration unit 21, a longitudinal motion control unit 22, a lateral motion control unit 23, a state quantity estimation unit 24, and an actuator distribution calculation unit (hereinafter referred to also as ACT distribution calculation unit) 25.

The arbitration unit 21 performs arbitration between the driving operation by the driver and the control request by the AD function or ADAS function of the driving assist ECU 10. When the AD function and the ADAS function are in a deactivated state, the arbitration unit 21 outputs the driver operation information to the longitudinal motion control unit 22 and the lateral motion control unit 23. In contrast, when the control request for the avoidance control, etc., is acquired from the driving assist ECU 10, the arbitration unit 21 outputs the acquired control request to the longitudinal motion control unit 22 and the lateral motion control unit 23. In this case, the arbitration unit 21 provides the requested longitudinal acceleration to the longitudinal motion control unit 22, and the requested yaw rate yd and the requested slip angle βd to the lateral motion control unit 23.

The longitudinal motion control unit 22 acquires the driver operation information or the requested longitudinal acceleration from the arbitration unit 21. In addition, the longitudinal motion control unit 22 acquires the estimation result of the vehicle state quantity and the calculation result of the vehicle response from the state quantity estimation unit 24. The longitudinal motion control unit 22 controls the longitudinal motion of the host vehicle Vh according to the requested longitudinal acceleration, etc. In the longitudinal motion control, feedback control and feed-forward control, etc., are used together for acceleration in the longitudinal direction. The longitudinal motion control unit 22 calculates a target longitudinal force based on the requested longitudinal acceleration, etc., and outputs the calculated target longitudinal force to the ACT distribution calculation unit 25.

From the arbitration unit 21, the lateral motion control unit 23 acquires the driver operation information or acquires the requested yaw rate yd and the requested slip angle βd. In addition, the lateral motion control unit 23 acquires the estimation result of the vehicle state quantity and the calculation result of the vehicle response from the state quantity estimation unit 24. The lateral motion control unit 23 controls the lateral motion of the host vehicle Vh according to the requested yaw rate yd, the requested slip angle βd, etc. In the lateral motion control, transient response control and feedback control, etc. are used together for the lateral position of the host vehicle Vh. The lateral motion control unit 23 calculates a target yaw rate and a target vehicle body slip angle based on the requested yaw rate yd and the requested slip angle βd, etc. The lateral motion control unit 23 outputs the calculated target yaw rate and the calculated target vehicle body slip angle to the ACT distribution calculation unit 25.

The state quantity estimation unit 24 acquires the actuator information and the vehicle information. The state quantity estimation unit 24 reads the actuator information and ascertains the presence or absence of the rear steering actuator 44, the hardware constraint (restriction values of steering angle and steering angle speed) of each steering actuator 43, 44, etc. The state quantity estimation unit 24 transmits the ascertained information of these kinds based on the actuator information to the avoidance determination unit 11 and the ACT distribution calculation unit 25, etc. In addition, based on the vehicle information, the state quantity estimation unit 24 ascertains the latest vehicle state quantity such as vehicle body speed, tire wheel speed, front wheel steering angle of, rear wheel steering angle δr, and actual yaw rate, as well as estimates the vehicle state quantity such as the actual slip angle. In addition, the state quantity estimation unit 24 calculates the vehicle response (yaw response) based on the vehicle information. The state quantity estimation unit 24 outputs the estimation result of the vehicle state quantity and the calculation result of the vehicle response to the lateral motion control unit 23, the state quantity estimation unit 24, and the ACT distribution calculation unit 25, etc.

The ACT distribution calculation unit 25 acquires the target longitudinal force, the target yaw rate, and the target vehicle body slip angle. The ACT distribution calculation unit 25 calculates operation distribution of the actuator group 40 based on the acquired target values, and sets a requested longitudinal force, a requested front wheel steering angle of, and a requested rear wheel steering angle δr. The ACT distribution calculation unit 25 outputs a control command (braking request, braking control value) of a braking force based on the requested longitudinal force to the brake system 42. The ACT distribution calculation unit 25 may output a braking request command based on the requested longitudinal force to the drive device 41. The ACT distribution calculation unit 25 outputs a control command (steering request, steering control value) to steer the front wheel unit 60f into the front wheel steering angle δf to the front steering actuators 43. The ACT distribution calculation unit 25 outputs a steering request command to steer the rear wheel unit 60r into the rear wheel steering angle δr to the rear steering actuator 44.

### <Details of Driving Assist Flow for Obstacle Avoidance>.

Next, a driving assist method of assisting avoidance of collision with an obstacle (pedestrian Pd) in the driving of the host vehicle Vh will be described. In the driving assist scene shown in FIG. 2, a pedestrian Pd suddenly appears in front of the host vehicle Vh from an obstruction SO. In this scene, if the braking control alone cannot avoid the obstacle collision, it is necessary to move in the lateral direction by using the steering control in combination with the braking control. Specifically, in the avoidance control in this scene, the braking control of the host vehicle Vh is started at time t1, and then the steering control of the host vehicle Vh is started at time t2. A time period from time t1 to time t2 is a braking control time period Pci included in an avoidance control time period Pc, wherein the braking control time period Pci is a time period where the braking control alone is performed, and the avoidance control time period Pc is a time period where the avoidance control is performed. After time t2 is a cooperative control time period Pce included in the avoidance control time period Pc, wherein the cooperative control time period Pce is a time period where cooperative control of braking and steering is performed.

By way of example, it is assumed that the rear wheel steering angle δr is controlled to be in opposite phase with the front wheel steering angle δf to generate a yaw moment so that the obstacle is circumvented laterally. However, as shown in FIG. 4, in a full braking state where a maximum longitudinal force Fx on the tire is generated, a lateral force Fy on the tire is reduced in a peak region Pf where a coefficient of friction between the tire and the road surface becomes maximum. As a result, the lateral force Fy on the tire may be insufficient, leading to reduction in lateral movement amount. Also, exceeding the limit of the friction circle Fcf, For shown in FIG. 3 may encourage slip in the longitudinal direction, which in turn may make the host vehicle Vh unstable.

By way of another example, such avoidance control is assumed that controls the front wheel steering angle δf and the rear wheel steering angle δr in phase with each other, thereby suppresses the yaw rate γ of the host vehicle Vh into approximately zero. In this avoidance control, the vehicle body slip angle β and resultant lateral force Fy are generated as rarely as possible and a rolling direction of the tire is directed into an avoidance direction, so that the obstacle is circumventable by lateral movement. However, the target path Tdn in the avoidance control not using the yaw motion (see FIG. 2 for the long-dashed arrow) may have a shortage of lateral movement per unit time.

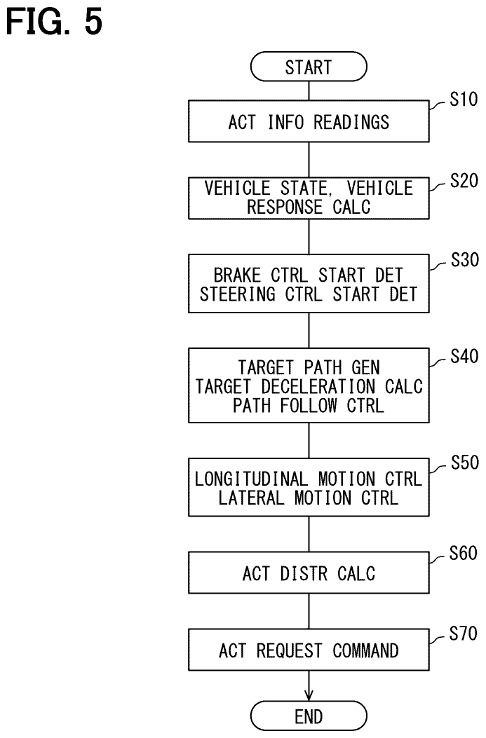

In view of the above, the driving assist method of the present embodiment includes calculating the target path Td (see FIG. 2 for the dashed-dotted arrow) where the vehicle body slip angle β due to controlling the front wheel steering angle δf and the rear wheel steering angle δr in phase with each other and the yaw rate γ due to the difference between the front wheel steering angle δf and the rear front wheel steering angle δr are generated. Details of the driving assist flow of this avoidance control will be described based on FIGS. 5 and 6 referencing to FIGS. 1 to 3.

The driving assist flow is repeatedly executed in accordance with FIG. 5 by cooperation between the driving assist ECU 10 and the motion control ECU 20 while the host vehicle Vh is active. In the below description, each “S” in the driving assist flow refers to a respective one of steps that are executed when a driving assist program with a plurality of instructions for assisting obstacle collision avoidance in the driving of the host vehicle Vh is executed.

In S10 of the driving assist flow, the state quantity estimation unit 24 reads the actuator information and thereby ascertains steering operation feasibility of the front wheel unit 60f and the rear wheel unit 60r, and the restriction values of the steering angle and the steering angle speed. In S20, the state quantity estimation unit 24 estimates the vehicle state quantity and calculates the vehicle response. Furthermore, the state quantity estimation unit 24 transmits information indicating the in-phase and opposite-phase steering feasibility of the front wheel unit 60f and the rear wheel unit 60r to the avoidance determination unit 11 and other units.

In S30, the avoidance determination unit 11 performs the prediction as to the collision with the obstacle and determines necessity of the obstacle avoidance control, based on the external information and the vehicle information. When the obstacle avoidance control is necessary, the avoidance determination unit 11 makes the determination as to start of each of the braking control and the steering control. In this case, the avoidance determination unit 11 transmits the braking control start flag and the steering control avoidance flag to the path generation unit 12.

The braking control start flag changes from OFF to ON at a start time t1 of the avoidance control time period Pc and the braking control time period Pci. The steering control start flag changes from OFF to ON at the start time t2 of the cooperative control time period Pce. The braking control start flag and the steering control start flag are kept at ON state until the end of the avoidance control time period Pc and the cooperative control time period Pce at a time t10, and changes from ON to OFF at time t10.

In S40, the path generation unit 12 generates the target path Td. The path generation unit 12 calculates the target path Td based on the assumption that the vehicle body slip angle β and the yaw rate γ are both generated in the cooperative control time period Pce. The path generation unit 12 plans the target path Td where, after the host vehicle Vh circumvents the obstacle (time t9 to t10), the yaw rate γ in a direction opposite to a direction before the host vehicle Vh circumvents the obstacle is generated.

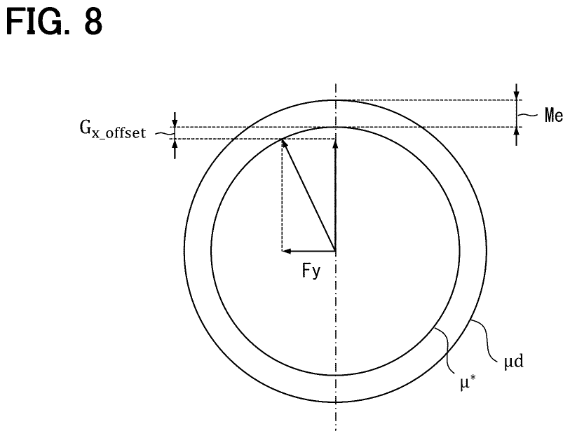

The target generation unit 14 calculates the requested longitudinal acceleration for decelerating the host vehicle Vh in accordance with the target path Td and transmits the calculated requested longitudinal acceleration to the arbitration unit 21. The requested longitudinal acceleration is set so that the braking force becomes maximum in the braking control time period from time t1 to time t2. The target generation unit 14 adjusts the requested longitudinal acceleration at time t2 so that the limit of the tire friction circle Fcf, For is not exceeded, in other words, a margin of the lateral force Fy on the tire is ensured (see FIG. 8). The shape of the friction circle Fcf, For is not limited to an exact circular shape. The shape of the friction circle Fcf, For may be elliptical or distorted elliptical, etc.

The target generation unit 14 decreases the braking force in the cooperative control time period Pce after the start of the steering control as compared with the braking control time period Pci before the start of the steering control. As a result, a rate of decrease in body vehicle speed per unit time in the cooperative control time period Pce is smaller than a rate of decrease in vehicle body speed per unit time in the braking control time period Pci.

The following control unit 13 calculates the requested yaw rate yd and the requested slip angle βd for the host vehicle Vh to move laterally while following the target path Td and transmits these calculated values to the avoidance determination unit 11. The following control unit 13 increases the requested yaw rate yd in the time period from time t2 to time t3 and in the time period from time t5 to time t6, wherein time t2 is immediately after the start of the steering control, and time t5 is immediately after the rear wheel steering angle δr reaches the maximum steering angle δrm being the upper limit. The following control unit 13 decreases the requested yaw rate yd to zero in the time period from time t7 to time t8.

If the yaw rate γ is generated in the avoidance direction and the steering control is ended while the host vehicle Vh has the yaw angle, the host vehicle Vh may stick out from the lane after end of the steering control because of inertia. In view of this, at a final stage (time t9 to t10) of the cooperative control time period Pce after the obstacle is circumvented, the following control unit 13 performs control so that the yaw rate γ in direction opposite to the circumventing direction is generated and a heading direction of the host vehicle Vh aligns with the lane direction. The time period from time t2 to time t10 is a generation interval Pgy of the yaw rate γ.

The following control unit 13 starts rise of the requested yaw rate yd and thereafter starts rise of the requested slip angle βd. The following control unit 13 decreases the requested slip angle βd to zero in the time period from time t8 to time t9, wherein time t8 is a time when the requested yaw rate yd is set to zero and time t9 is a time when the requested yaw rate yd in the opposite direction is set. The time period during which the requested slip angle βd continuously increases or decreases is a slope interval Pgs of the vehicle body slip angle β.

In S50, the longitudinal motion control unit 22 performs the longitudinal motion control to generate the longitudinal acceleration of the host vehicle Vh (braking acceleration) in accordance with the acquired requested longitudinal acceleration. Specifically, the longitudinal motion control unit 22 calculates the target longitudinal force based on the requested longitudinal acceleration and transmits the calculated target longitudinal force to the ACT distribution calculation unit 25. The lateral motion control unit 23 performs the lateral motion control to generate the lateral movement of the host vehicle Vh according to the acquired requested yaw rate yd and the acquired requested slip angle βd. Specifically, the lateral motion control unit 23 calculates the target yaw rate and the target vehicle body slip angle and transmits these calculated values to the ACT distribution calculation unit 25.

In S60, the ACT distribution calculation unit 25 calculates the actuator distribution for generating the target longitudinal force, the target yaw rate, and the target vehicle body slip angle at the host vehicle Vh. Specifically, the ACT distribution calculation unit 25 calculates the requested longitudinal force and the requested value of each of the front wheel steering angle δf and the rear wheel steering angle δr. The ACT distribution calculation unit 25 sets so that the front wheel steering angle δf is larger than the rear wheel steering angle δr in order to generate the yaw rate γ in the avoidance direction. In S70, the ACT distribution calculation unit 25 transmits these calculated values to the actuator group 40 as request commands.

The ACT distribution calculation unit 25 continuously increases the front wheel steering angle δf in the time period from time t2 to time t6. The ACT distribution calculation unit 25 keeps the front wheel steering angle δf in a time period from time t6 to time t7 and returns the front wheel steering angle δf to zero in a time period from time t7 to time t9. The front wheel steering angle δf may be kept at a maximum steering angle ofm based on the below-described lateral acceleration constraint in the time period from time t6 to time t7. In a time period from time t9 to time t10, the ACT distribution calculation unit 25 sets the front wheel steering angle δf in a direction opposite to the previous direction.

In the time period from time t2 to time t3, the ACT distribution calculation unit 25 steers the rear wheel unit 60r once so that the rear wheel steering angle δr is in opposite phase with the front wheel steering angle δf in order to rise the yaw rate γ. In the time period from time t3 to time t4, the ACT distribution calculation unit 25 returns the steering angle δr of the rear wheel steered in the opposite phase to zero. Furthermore, in the time period from time t4 to time t5, the ACT distribution calculation unit 25 changes the rear wheel steering angle δr so that the rear wheel steering angle or is in phase with the front wheel steering angle of. The rear wheel steering angle δr becomes the maximum steering angle δrm based on the hardware constraint at time t5 and is kept at the maximum during the time period from time t5 to time t8. In the time period from time t8 to time t9, the ACT distribution calculation unit 25 decreases the rear wheel steering angle δr to zero. The ACT distribution calculation unit 25 may keep the rear wheel steering angle δr at zero during the time period from time t9 to time t10, or may set the rear wheel steering angle δr in the opposite direction so that the rear wheel steering angle δr is in phase with the front wheel steering angle of.

The driving assist system 100 may stop the host vehicle Vh and thereafter end the avoidance control. Alternatively, while the host vehicle Vh is still in motion, the driving assist system 100 may hand over driving operation control to the driver.

### <Notable Calculation Process in Driving Assist Flow>.

Next, notable calculation processes performed in steps of the driving assist flow will be described in detail.

### <<Setting of Constraint on Path Calculation>>.

In the path calculation in S40 of the driving assist flow, the lateral acceleration of the host vehicle Vh in the slope interval Pgs of the vehicle body slip angle β and the generation interval Pgy of the yaw rate γ is set is less than or not more than the restriction value so as not to exceed the restriction value. A system upper limit value which is preset in the driving assist system 100 (application) or the margin of the estimated lateral force Fy on the tire (see FIG. 8), whichever is smaller, is used as the restriction value of the lateral acceleration.

In the path calculation in S40, the steering angle speed of each of the front wheel unit 60f and the rear wheel unit 60r in the slope interval Pgs of the vehicle body slip angle β and the generation interval Pgy of the yaw rate γ is set less than or not more than the restriction value so as not to exceed the restriction value. The steering angle speed is an angular velocity representing an amount of change in steering angle per unit time. A system upper limit value which is preset in the driving assist system 100 (application) or an upper limit value which is based on a hardware requirement of the front steering actuator 43, whichever is smaller, is used as the restriction value of the steering angle speed of the front wheel unit 60f. An upper limit which is based on a hardware requirement of the rear steering actuator 44 is used as the restriction value of the steering angle speed of the rear wheel unit 60r.

The path generation unit 12 calculates the path of the host vehicle Vh so that the host vehicle Vh circumvents the obstacle without sticking out from the traveling lane based on the recognition data on the road ahead and the obstacle recognized by the avoidance determination unit 11. The path generation unit 12 first set a minimum path in which the lateral movement amount is minimized and a maximum path which allows the lateral movement amount to become maximum. As the target path Td, the path generation unit 12 calculates a path that passes through a region sandwiched between the minimum path and the maximum path while satisfying the above-described constraints on the lateral acceleration and the steering angle velocity.

### <<Correction of Road Shape>>.

In the path following control in S40 of the driving assist flow, when the host vehicle Vh is traveling on a curve section, the requested yaw rate yd is calculated taking into account a road curvature of the curve section (hereinafter “curve curvature”). The following control unit 13 calculates a correction yaw rate for correction on (canceling out) an influence of the curve curvature on the lateral movement based on the recognition data on the road ahead generated by the avoidance determination unit 11. The following control unit 13 calculates the requested yaw rate yd by adding the correction yaw rate, which is for correction on the curve curvature, to a base yaw rate for achieving the obstacle avoidance path and transmits the requested yaw rate yd to the motion control ECU 20.

In the path following control of S40, when the host vehicle Vh is traveling on a cant road surface, the requested yaw rate yd is calculated taking into account the inclination of the cant road surface. The following control unit 13 calculates a correction yaw rate for correction on (canceling out) an influence of the cant road surface inclination on the lateral movement based on the recognition data on the road ahead generated by the avoidance determination unit 11. The following control unit 13 calculates the requested yaw rate yd by adding the correction yaw rate, which is for correction on the inclination of the cant, to the base yaw rate for achieving the obstacle avoidance path and transmits it to the motion control ECU 20.

<<Adjustment of Requested Longitudinal Acceleration Taking into Account Steering Control>>.

In the target deceleration calculation in S40 of the driving assist flow, the requested longitudinal acceleration not causing the tire friction circle Fcf, For to be exceeded is calculated from an estimation result of the friction coefficient between the tire and the road surface based on the restriction value of the lateral acceleration (system upper limit value) and is transmitted to the motion control ECU 20.

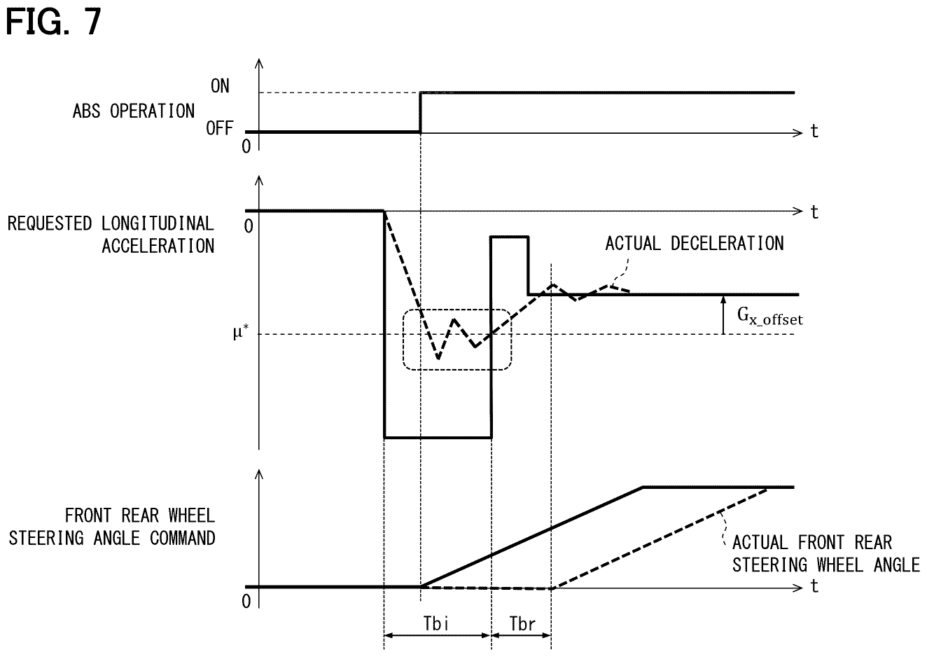

More specifically, as shown in FIG. 7, when the ABS is activated after commanding the Pre-Crash Brake (PB) in the braking control time period Pci, the state quantity estimation unit 24 estimates a deceleration (hereinafter, estimated maximum deceleration μ*) at which the coefficient of friction between the tire and the road surface becomes maximum from the actual deceleration during the ABS operation. By way of example, as shown in FIG. 8, the detected maximum acceleration μd minus a given estimated margin Me is the estimated maximum deceleration μ*.

When the ABS is not activated after commanding the PB, the state quantity estimation unit 24 can regard a generated given deceleration as the estimated maximum deceleration μ*. When the coefficient of friction between the tire and the road surface is constantly estimated at the host vehicle Vh, the estimated maximum deceleration μ* may be set using the coefficient of friction estimated before the PB command.

Based on the estimated maximum deceleration μ*, the target generation unit 14 calculates the requested longitudinal acceleration that can ensure a margin of the lateral force Fy on the tire necessary to generate the requested yaw rate yd. As shown in FIGS. 7 and 8, after steering the front wheel unit 60f and the rear wheel unit 60r is started, the target generation unit 14 sets the requested longitudinal acceleration to a value that is obtained by subtracting a deceleration offset amount Gx_offset from the estimated maximum deceleration μ* The offset amount Gx_offset is given by the following mathematical expression 2 using a yaw rate g (requested yaw rate yd), a requested vehicle body slip angle change amount ω+γ determined by the path calculation, and the vehicle body speed V.

$${G}_{x\_offset} = {μ}^{*} - \sqrt{{( {μ}^{*} )}^{2} - {\{ V ( ω + γ ) / g \}}^{2}} . \qquad ( Mathematical Expression 2 )$$

The target generation unit 14 changes the requested longitudinal acceleration taking into account a brake response time Tbi on an increase side and a brake response time Tbr on a decrease side. The target generation unit 14 adjusts the requested longitudinal acceleration so as to decrease the braking force after start of the steering control as compared with before start of the steering control. As the offset amount Gx_offset, the target generation unit 14 uses a smaller value (value causing a larger deceleration) among the value calculated from the mathematical expression 2 and a preset value so that the decrease amount of the requested longitudinal acceleration is not insufficient.

In order to provide prompt decrease in deceleration decrease before start of steering the front wheel unit 60f and the rear wheel unit 60r, the target generation unit 14 temporarily subtracts a value greater than the above offset amount Gx_offset from the requested longitudinal acceleration. When the actual deceleration becomes close to the requested longitudinal acceleration, the target generation unit 14 changes the temporarily decreased requested longitudinal acceleration into a value corresponding to the offset amount Gx_offset in order to prevent overshoot.

<<Path Calculation Taking into Account Deceleration in Steering Control>>.

According to the target deceleration calculation described above, the vehicle body speed V of the host vehicle Vh decreases in the cooperative control time period Pce (see FIG. 6). For this reason, the path calculation in S40 takes into account the deceleration of the host vehicle Vh. Specifically, the front wheel steering angle of and the rear wheel steering angle δr are given by the below mathematical expression 3 using the yaw rate γ and the vehicle body slip angle β.

$$( \begin{matrix}δ f \\ δ r\end{matrix} ) = {( \begin{matrix}Grf & Grr \\ Gbf & Gbr\end{matrix} )}^{- 1} ( \begin{matrix}γ \\ β\end{matrix} ) . \qquad ( Mathematical Expression 3 )$$

In the above mathematical expression 3, Grf is a steady gain of the yaw rate γ with respect to the front wheel steering angle of, and Grr is a steady gain of the yaw rate γ with respect to the rear wheel steering angle δr. Gbf is a steady gain of the vehicle body slip angle β with respect to the front wheel steering angle of, and Gbr is a steady gain of the vehicle body slip angle β with respect to the rear wheel steering angle or. These steady gains Grf, Grr, Gbf, Gbr are given by the below mathematical expressions 4 to 7.

$${G}_{rf} = \frac{1}{1 + {AV}^{2}} \frac{V}{l} . \qquad ( Mathematical Expression 4 )$$

$${G}_{rr} = - \frac{1}{1 + {AV}^{2}} \frac{V}{l} . \qquad ( Mathematical Expression 5 )$$

$${G}_{bf} = \frac{1 - \frac{m}{2 l} \frac{{l}_{f}}{{l}_{r} {K}_{r}} {V}^{2}}{1 + {AV}^{2}} \frac{{l}_{r}}{l} . \qquad ( Mathematical Expression 6 )$$

$${G}_{br} = \frac{1 + \frac{m}{2 l} \frac{{l}_{r}}{{l}_{f} {K}_{f}} {V}^{2}}{1 + {AV}^{2}} \frac{{l}_{f}}{l} . \qquad ( Mathematical Expression 7 )$$

In the above mathematical expressions 4 to 7, m is mass of the host vehicle Vh. I is wheelbase of the host vehicle Vh. If is distance from the front wheel unit 60f to the center of gravity. Ir is distance from the rear wheel unit 60r to the center of gravity. Kf is cornering power of the front wheel unit 60f. Kr is cornering power of the rear wheel unit 60r. V is the vehicle body speed. A is a stability factor representing steering characteristics of the host vehicle Vh. This stability factor A is given by the below mathematical expression 8.

$$A = - \frac{m}{2 {l}^{2}} \frac{{l}_{f} {K}_{f} - {l}_{r} {K}_{r}}{{K}_{f} {K}_{r}} . \qquad ( Mathematical Expression 8 )$$

As in the above mathematical expressions 4 to 7, the mathematical expressions defining the steady gains Grf, Grr, Gbf, Gbr include the vehicle body speed V of the host vehicle Vh. Therefore, as the host vehicle Vh decelerates due to the braking control in the steering control, the steady gains Grf, Grr, Gbf, Gbr also change. In view of this, the path generation unit 12 calculates the target path Td taking into account the change in the steady gain Grf, Grr, Gbf, Gbr.

As in the above mathematical expression 8, the mathematical expression defining the stability factor A includes the cornering power Kf of the front wheel unit 60f and the cornering power Kr of the rear wheel unit 60r. The cornering power Kf, Kr increases or decreases with change in ground load on the front wheel unit 60f and the rear wheel unit 60r, wherein the ground load on the tires change as the host vehicle Vh decelerates. Therefore, as the host vehicle Vh decelerates, the cornering power Kf, Kr changes and consequently the stability factor A also changes. In view of this, the path generation unit 12 calculates the target path Td taking into account the change in stability factor A.

### <<Cornering Power as Variable>>.

In the longitudinal motion control in S50 and the actuator distribution calculation in S60 of the driving assist flow, the longitudinal motion control unit 22 and the ACT distribution calculation unit 25 perform control for promptly achieving the requested longitudinal acceleration received from the following control unit 13. Furthermore, in the lateral motion control of S50 and the actuator distribution calculation of S60, the lateral motion control unit 23 and the ACT distribution calculation unit 25 calculate the target front wheel steering angle δf and the rear wheel steering angle δr from the respective values of the target yaw rate and the target vehicle body slip angle and the value of the current vehicle body speed V.

At this time, the lateral motion control unit 23 or the ACT distribution calculation unit 25 estimates the ground load on the front wheel unit 60f and the rear wheel unit 60r from the longitudinal acceleration value and sets the cornering power Kf, Kr corresponding to the ground load. By treating the cornering power Kf, Kr in the lateral motion control as variable, the front wheel steering angle δf and the rear wheel steering angle δr for achieving the target yaw rate and the target vehicle body slip angle are calculated with high accuracy by using the above mathematical expressions 3 to 8.

### <<Feedback Control of Lateral Movement>>.

In the path following control in S40 of the driving assist flow, feedback control of the vehicle body slip angle β and yaw rate γ is performed for improving performance of following the target path Td. The following control unit 13 performs the feedback control of the vehicle body slip angle β and the yaw rate γ according to deviation of measured values from the target values of the lateral position, the lateral speed, the yaw angle, and the yaw rate γ of the host vehicle Vh based on the target path Td.

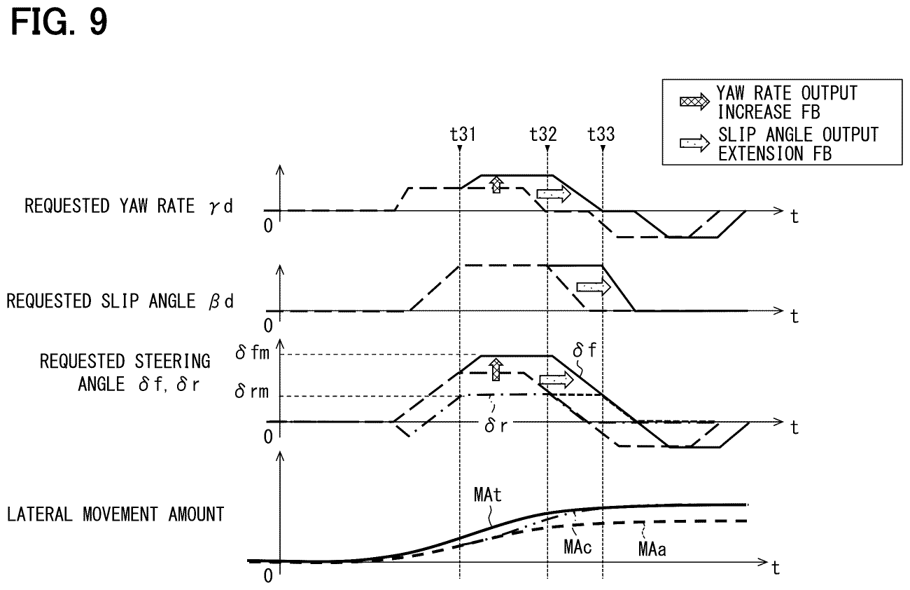

As shown in FIG. 9, there may happen a scene where it is impossible to increase the rear wheel steering angle δr to above the maximum steering angle δrm due to the hardware constraint even when tan actual lateral movement amount MA is insufficient with respect to the target value of the lateral movement amount (hereinafter referred to as “target lateral movement amount MAt”).

When the actual lateral movement amount MAa deviates from the target lateral movement amount MAt and the shortage of the measured value with respect to the target value of the lateral movement amount exceeds a threshold (see time t31), the following control unit 13 increases the requested yaw rate yd. Via this yaw-rate output increase feedback control (see FIG. 9 for the shaded arrow), the ACT distribution calculation unit 25 increases the front wheel steering angle δf requested to the front steering actuator 43, thereby increasing the yaw rate γ. For example, the ACT distribution calculation unit 25 increases the front wheel steering angle δf to the maximum steering angle ofm corresponding to the restriction value of the lateral acceleration (see FIG. 9 for the solid line of the requested steering angle).

In addition, when the shortage of the measured value of the lateral movement with respect to the target value exceeds the threshold, the following control unit 13 extends a time period during which the rear wheel steering angle δr is kept at the maximum steering angle δrm, in other words, extends a time period during which the vehicle body slip angle β is kept at maximum. The following control unit 13 shifts time t32 of start of decrease in the requested slip angle βd to a later time to prolong to time t33. Via this slip angle output extension feedback control (see FIG. 9 for the dotted arrow), the ACT distribution calculation unit 25 extends a maximum-keeping duration of the rear wheel steering angle δr requested to the rear steering actuator 44 (see FIG. 9 for the dashed line for the requested steering angle).

According to the above combination of the yaw rate output increase feedback control and the slip angle output extension feedback control, it is possible to increase the actual lateral movement amount MAa of the host vehicle Vh and achieve the actual lateral movement amount MAc after the correction reaching the target lateral movement amount MAt When it is sufficient with respect to the restriction value of the lateral acceleration, the yaw-rate output increase feedback control may be performed preferentially over the slip angle output extension feedback control.

### Overview of Embodiment

In the present embodiment described above, when the host vehicle Vh is decelerated with lateral movement, the rear wheel steering angle δr is controlled in phase with the front wheel steering angle of, so that the host vehicle Vh is less likely to become unstable. In addition, because the yaw rate γ is generated due to the difference in steering angle of, of between the front wheel and the rear wheel steered in phase with each other, it is possible to facilitate ensuring the lateral movement amount. According to the above, even when the host vehicle Vh is decelerated with lateral movement, it is possible to suppress the reduction in the lateral movement amount while ensuring the stability of the host vehicle Vh.

In addition, the present embodiment generates the target path Td where the lateral acceleration of the host vehicle Vh does not exceed the restriction value in the slope interval Pgs of the vehicle body slip angle β and in the generation interval Pgy of the yaw rate γ. By generating the target path Td satisfying the constraint on the maximum lateral acceleration, it is possible to suppress behavior instability of the laterally moving host vehicle Vh.

In addition, the present embodiment calculates the target path where the steering angle speed of each of the front wheel unit 60f and the rear wheel unit 60r does not exceed the restriction value in the slope interval Pgs of the vehicle body slip angle β and in the generation interval Pgy of the yaw rate γ. By generating the target path Td satisfying the constraint on the steering angle speed, it is possible to suppress behavior instability of the laterally moving host vehicle Vh.

Furthermore, in the present embodiment, the correction yaw rate is added to the base yaw rate, wherein the correction yaw rate is for correction on the influence of at least one of: the curve curvature of the road where the host vehicle Vh is traveling; or the road surface cant of the road on the lateral movement. Therefore, even in the scene where the host vehicle Vh is traveling on a curve section, a road surface with cant, etc., it is possible to reduce or cancel out the influence and appropriately control the lateral movement of the host vehicle Vh to keep the host vehicle Vh in the lane.

In addition, the present embodiment calculates, based on the forward information of the host vehicle Vh, the target path Td for the host vehicle Vh to circumvent the pedestrian Pd by laterally moving while decelerating. In the scene of circumventing the pedestrian Pd or the like, it is important to ensure the lateral movement amount. Therefore, the path where the yaw rate γ is generated due to the difference in steering angle of, or between the front wheel and the rear wheel steered in phase with each other is suitable to circumvent the pedestrian Pd or the like.

The present embodiment plans the target path where, after the host vehicle Vh circumvents the pedestrian Pd, the yaw rate γ is generated so that the direction of the yaw rate γ generated after circumventing the pedestrian Pd is opposite to that generated before circumventing the pedestrian Pd. This prevents the host vehicle Vh from sticking out from the lane due to inertia after end of the steering control.

Furthermore, the present embodiment plans the target path Td where the steering control is started after the braking control is started. In this case, the estimated maximum deceleration μ* at a time when the coefficient of friction between the tire and the road surface peaks is estimated from the actual deceleration during the ABS operation before the start of the steering control. Then, the target generation unit 14 decreases the braking force after the start of the steering control as compared with before the start of the steering control so as to ensure the margin of the lateral force Fy of the tire necessary to generate the yaw rate γ based on the estimated maximum deceleration μ*. According to the above, in the cooperative control time period Pce, it is possible to generate the lateral force Fy on the tire without running out of the friction circle Fcf, For by the longitudinal force alone, so that the lateral movement amount can be ensured.

In addition, the present embodiment calculates the target path Td taking into account the change in steady gain Grf, Grr, Gbf, Gbr and the change in stability factor A of the host vehicle Vh which are caused by the deceleration of the host vehicle Vh due to the braking control in the steering control, Because the calculation in generating the target path Td takes into account the decrease in vehicle speed V in the steering circumventing as described above, execution of the braking control and the steering control to follow the target path Td is facilitated.

In the present embodiment, the requested slip angle βd and the requested yaw rate yd for following the target path Td and the current vehicle speed V of the host vehicle Vh are used to calculate the control value of each of the front wheel steering angle of and the rear wheel steering angle δr. Furthermore, the ground load on each of the front wheel unit 60f and the rear wheel unit 60r is estimated from the value of the deceleration of the host vehicle Vh, and the cornering power Kf, Kr of each of the front wheel unit 60f and the rear wheel unit 60r is variable according to the ground load. By taking into account the increase or decrease in cornering power Kf and Kr caused by load transfer due to the deceleration as described above, execution of the braking and the steering control to follow the target path Td is facilitated.

Furthermore, in the present embodiment, the feedback control of the vehicle body slip angle β and the yaw rate γ is performed according to the deviation between the actual lateral movement amount MAa of the host vehicle Vh and the target lateral movement amount MAt based on the target path Td. When there is a shortage of actual lateral movement amount MAa with respect to the target lateral movement amount MAt, the control to increase the yaw rate γ by steering the front wheel unit 60f to increase the front wheel steering angle δf is performed. Thus, by the control to increase the steering amount of the front wheel unit 60f and consequently increase the output of the yaw rate γ, it is possible to improve performance of following the target path Td even when the constrain on the rear wheel steering angle δr is present.

In addition, in the present embodiment, when there is a shortage of actual lateral movement amount MAa with respect to the target lateral movement amount MAt, the control to extend the time period during which the rear wheel steering angle δr is kept at maximum is performed. Thus, by the control to extend the time period during which the steering amount of the rear wheel unit 60r and consequently the vehicle body slip angle β are kept at maximum, it is possible to facilitate ensuring the lateral movement amount. As a result, it is possible to improve performance of following the target path Td.

In the present embodiment, when starting the steering control in accordance with the target path Td, the control is performed such that steering the rear wheel for the rear wheel steering angle δr to be in opposite phase with the front wheel steering angle δf is performed and thereafter the change for the rear wheel steering angle δr to be in phase with the front wheel steering angle δf is performed. According to the steering control to generate the yaw rate γ at the rear wheel unit 60r by the above operations of the rear steering actuator 44, it is possible to improve rise of lateral movement response.

In the above embodiment, the storage 33, 38 corresponds to “storage medium”. The front steering actuator 43 and the rear steering actuator 44 correspond to “steering actuator”. The pedestrian Pd corresponds to “object”. The requested slip angle βd corresponds to “requested value of vehicle body slip angle”. The requested yaw rate yd corresponds to “requested value of yaw rate”. The estimated maximum deceleration μ* corresponds to “maximum deceleration. The target lateral movement amount MAt corresponds to “target value of lateral movement” and the actual lateral movement amount MAa corresponds to “measured value of lateral movement.”

### Other Embodiments

Although one embodiment according to the present disclosure has been described above, the present disclosure is not construed as being limited to the embodiment and can be applied to various embodiments and combinations without departing from the spirit and scope of the present disclosure.

The vehicle-mounted ECU functioning as the driving assist ECU 10 and the motion control ECU 20 may be modified as needed. In a modification example, the driving assist ECU 10 may be a recognition ECU that recognizes the driving environment, a locator ECU that estimates the position thereof, or a navigation ECU that navigates the driving route. The motion control ECU 20 may be an actuator ECU that controls an actuator group 40 or a central ECU that relays between multiple ECUs.

In addition, at least part of functions of the driving assist ECU 10 and the motion control ECU 20 may be implemented, for example, in a mobile terminal connected to the in-vehicle network of the host vehicle Vh, or in a computer at an external center communicable with the host vehicle Vh. Furthermore, an integrated ECU into which functions of the driving assist ECU 10 and functions of the motion control ECU 20 are integrated may constitute “driving assist system”.

In a modification example, the target path Td where the host vehicle is decelerated with lateral movement is applicable to paths other than that for avoiding the pedestrian Pd, etc. For example, the target path Td described above may be applied to a path related to a lane change. In a modification example, the target path Td may be planned where the vehicle sticks out of a traveling lane to avoid an object.

In a modification example, the dedicated computer implementing the driving assist ECU 10 and the motion control ECU 20 may include at least one of a digital circuit or an analog circuit as the processor. The digital circuit is, for example, of at least one kind among ASIC, FPGA, SOC, PGA, CPLD, etc. ASIC is Application Specific Integrated Circuit. FPGA is Field Programmable Gate Array. SOC is System on a Chip. PGA is Programmable Gate Array. CPLD is Complex Programmable Logic Device. The digital circuit may include a memory storing a program.

In a modification example, the operator who manually drives the host vehicle Vh applied with the driving assist system 100 may be a remote operator who remotely drives the host vehicle Vh from an external center. The driving assist system 100 may be configured such that a manual driving assist task for assisting the manual driving operation of the operator is absent and an automatic driving task is feasible.

Combinations of “not less than/less than” and “greater than/not greater than” when making determinations based on comparisons with thresholds in respective processes of the above embodiments may be modified as appropriate. Specifically, it may not matter whether a case where a determination target value is equal to the threshold value is included in a case where the determination target value is not less than the threshold or a case where the determination target value is not more than the threshold.

The control unit and the method thereof described in the present disclosure may be implemented by a special purpose computer including a processor programmed to execute one or more functions embodied by a computer program. Alternatively, the control nit and the method thereof described in the present disclosure may be implemented by a dedicated hardware logic circuit. Alternatively, the control nit and the method thereof described in the present disclosure may be implemented by one or more dedicated computers provided by a processor that executes a computer program in combination with one or more hardware logic circuits. The computer program may be stored on a computer-readable non-transitory tangible storage medium as instructions executed by a computer.

What is claimed is:

1. A driving assist system for assisting driving of a host vehicle, comprising a computer, including at least one processor, configured to execute:
planning a target path of the host vehicle; and
controlling motion of the host vehicle in accordance with the target path by adjusting, with respect to a reference longitudinal direction, a front wheel steering angle of a front wheel unit and a rear wheel steering angle of a rear wheel unit which are given from steering actuators,
wherein planning the target path includes
calculating the target path where a vehicle body slip angle and a yaw rate are generated when the host vehicle is decelerated with lateral movement, wherein the vehicle body slip angle is due to controlling the front wheel steering angle and the rear wheel steering angle in phase with each other with respect to the reference longitudinal direction and the yaw rate is due to a difference between the front wheel steering angle and the rear wheel steering angle.

2. The driving assist system according to claim 1, wherein
planning the target path includes
calculating the target path where a lateral acceleration of the host vehicle does not exceed a restriction value in a slope interval of the vehicle body slip angle and in a generation interval of the yaw rate.

3. The driving assist system according to claim 1, wherein
planning the target path includes
calculating the target path where a steering angle speed of each of the front wheel unit and the rear wheel unit does not to exceed a restriction value in a slope interval of the vehicle body slip angle and in a generation interval of the yaw rate.

4. The driving assist system according to claim 1, wherein:
the yaw rate is a base yaw rate; and
planning the target path includes
adding a correction yaw rate for correction on an influence of at least one of: curve curvature of a road where the host vehicle is traveling; or a road surface cant on lateral movement to the base yaw rate.

5. The driving assist system according to claim 1, wherein
planning the target path includes
based on forward information of the host vehicle, calculating the target path for the host vehicle to circumvent an object by moving laterally while decelerating.

6. The driving assist system according to claim 5, wherein
planning the target path includes
planning the target path where, after the host vehicle circumvents the object, the yaw rate is generated so that a direction of the yaw rate after the host vehicle circumvents the object is opposite to that before the host vehicle circumvents the object.

7. The driving assist system according to claim 1, wherein
planning the target path includes
when planning the target path where steering control is started after braking control is started,
estimating a maximum deceleration at a time when a coefficient of friction between a tire and road surface peaks, from an actual deceleration during an ABS operation before start of the steering control, and
decreasing a braking force after the start of the steering control as compared with before the start of the steering control so that a margin of a lateral force on the tire necessary to generate the yaw rate is ensured.

8. The driving assist system according to claim 1, wherein
planning the target path includes
calculating the target path taking into account a change in steady gain of the yaw rate and the vehicle body slip angle with respect to the front wheel steering angle and the rear wheel steering angle and a change in stability factor of the host vehicle due to deceleration of the host vehicle by braking control in steering control.

9. The driving assist system according to claim 1, wherein
controlling the motion of the host vehicle includes:
calculating a control value of each of the front wheel steering angle and the rear wheel steering angle by using a requested value of each of the vehicle body slip angle and the yaw rate for following the target path and a current vehicle body speed of the host vehicle;
estimating a ground load on each of the front wheel unit and the rear wheel unit from a value of deceleration of the host vehicle; and
using cornering power of each of the front wheel unit and the rear wheel unit as variable according to the ground load.

10. The driving assist system according to claim 1, wherein
controlling the motion of the host vehicle includes:
performing feedback control of the vehicle body slip angle and the yaw rate according to: a deviation between a target value of lateral movement of the host vehicle based on the target path and a measured value of the lateral movement; and
when there is a shortage of the measured value of the lateral movement with respect to the target value, increasing the yaw rate by steering the front wheel unit to increase the front wheel steering angle.

11. The driving assist system according to claim 1, wherein
controlling the motion of the host vehicle includes:
performing feedback control of the vehicle body slip angle and the yaw rate according to a deviation between a target value of lateral movement of the host vehicle based on the target path and a measured value of the lateral movement; and
when there is a shortage of the measured value of the lateral movement with respect to the target value, extending a time period during which the rear wheel steering angle is kept at maximum.

12. The driving assist system according to claim 1, wherein
controlling the motion of the host vehicle includes
when starting steering control in accordance with the target path, steering the rear wheel unit so that the rear wheel steering angle is in opposite phase with the front wheel steering angle, and thereafter changing the rear wheel steering angle so that the rear wheel steering angle is in phase with the front wheel steering angle.

13. A driving assist method executed by a computer including at least one processor for assisting driving of a host vehicle, the driving assist method comprising:
planning a target path of the host vehicle; and
controlling motion of the host vehicle in accordance with the target path by adjusting, with respect to a reference longitudinal direction, a front wheel steering angle of a front wheel unit and a rear wheel steering angle of a rear wheel unit which are given from steering actuators,
wherein planning the target path includes
calculating the target path where a vehicle body slip angle and a yaw rate are generated when the host vehicle is decelerated with lateral movement, wherein the vehicle body slip angle is due to controlling the front wheel steering angle and the rear wheel steering angle in phase with each other with respect to the reference longitudinal direction and the yaw rate is due to a difference between the front wheel steering angle and the rear wheel steering angle.

14. A driving assist program stored on at least one non-transitory storage medium for assisting driving of a host vehicle, the driving assist program comprising instructions causing a computer to execute:
planning a target path of the host vehicle; and
controlling motion of the host vehicle in accordance with the target path by adjusting, with respect to a reference longitudinal direction, a front wheel steering angle of a front wheel unit and a rear wheel steering angle of a rear wheel unit which are given from steering actuators,
wherein planning the target path includes
calculating the target path where a vehicle body slip angle and a yaw rate are generated when the host vehicle is decelerated with lateral movement, wherein the vehicle body slip angle is due to controlling the front wheel steering angle and the rear wheel steering angle in phase with each other with respect to the reference longitudinal direction and the yaw rate is due to a difference between the front wheel steering angle and the rear wheel steering angle.
